(19) United States
(12) Patent Application Publication
(10) Pub. No.: US 2014/0280157 A1
(43) Pub. Date: Sep. 18, 2014

(54) MANAGEMENT OF DATA FEEDS FROM DEVICES AND PUBLISHING AND CONSUMPTION OF DATA

(71) Applicant: Aeris Communications, Inc., Santa Clara, CA (US)

(72) Inventors: Yixiang CHEN, Palo Alto, CA (US); Vikram VISWANATHAN, Saratoga, CA (US); Drew S. JOHNSON, San Jose, CA (US)

(73) Assignee: Aeris Communications, Inc., Santa Clara, CA (US)

(21) Appl. No.: 14/207,378

(22) Filed: Mar. 12, 2014

Related U.S. Application Data
(60) Provisional application No. 61/780,234, filed on Mar. 13, 2013.
(60) Provisional application No. 61/878,554, filed on Sep. 16, 2013.

(51) Int. Cl. G06F 17/30

(52) U.S. Cl. CPC G06F 17/30598; G06F 17/30507
USPC 707/737

(57) ABSTRACT

The present invention is directed towards a computer-implemented method and system for managing device data feeds. The computer-implemented method and system comprise using a data model to describe type of data received from the devices, grouping the received type of data based on a data description, and forwarding the device data to a receiver endpoint as directed by the subscription information comprising a receiver endpoint and a rule uniquely identified by the subscription identifier using application programming interface key to manage access to the device data.

### CROSS-REFERENCE TO RELATED APPLICATIONS

Under 35 USC 119(e), this application claims priority to U.S. provisional application Ser. No. 61/780,234, filed on Mar. 13, 2013 and U.S. provisional application Ser. No. 61/878,554, filed on Sep. 16, 2013.

### FIELD OF THE INVENTION

The present invention is directed to the management of data received from devices on a network.

### BACKGROUND

An increasing number of devices or machines are enabled for connectivity to cellular or other wireless network services, including telephones and tablet computers as well as devices designed for machine-to-machine communications, such as telematics devices in automobiles or devices enabled for monitoring and reporting on utilities or tracking assets. These devices may generate data that can be used for multiple purposes by a number of different parties, such as monitoring the operation of the device or the environment in which the device is operating.

Managing the data from devices so that data feeds can be stored, published and consumed according to the needs of different interested parties poses a significant challenge to every party in the data chain.

Many deployed devices, whether used by consumers or in machine-to-machine applications, send data to a central location for processing. Presently, however, simple receipt of data at a data center does not accommodate the needs of different entities and applications to use different data from the same device. For example, a car manufacturer may want all of the minute details regarding the operation of a moving vehicle for performance monitoring, while a car insurance company may only want data relating to mileage driven, location and speed. There may also be privacy considerations that would require limiting access of certain parties to certain data. Accordingly, there is a need to be able to transform raw device data before it is consumed by an end-user application and to authorize and manage access to that data. In addition, end users of the data may want some data to be pushed to their applications in real-time, and direct other applications to query the data store for relevant data, which is not accommodated by existing models for handling device data feeds. What is needed to solve these issues is a method and system providing one easy-to-use end-to-end solution that overcomes the above-identified issues.

The present invention addresses this need and allows all of the entities who have an interest in the use of network communications by a device and the data generated by that device to economically and accurately manage, process and use the data appropriate to them.

### SUMMARY OF THE INVENTION

In one or more embodiments, a computer-implemented method and system are disclosed. The computer-implemented method for managing device data feeds comprises using a data model at the destination database system that will receive and hold the data to describe the type of data received from each of a plurality of devices, grouping the received type of data into a plurality of containers based on a data description, configuring at least one subscription identifier to at least one of the plurality of containers, where each subscription identifier is associated with a receiver endpoint and at least one rule for processing the data uniquely identified by the subscription identifier, and using application programming interface key to manage access to the device data by the receiver.

The computer-implemented system for managing device data feeds comprises a gateway between one or more devices and one or more receiver endpoints, where the gateway is authorized to receive data feeds from such a device and to handle and, if applicable, store such data feeds, is configured with a data model of the data feed to be received from a given device to allow the gateway to interpret data received from the device, and subscription information associated with the data feed from that device where the subscription information comprises a receiver endpoint, and a rule for processing the data feed uniquely identified by the subscription's identifier.

This solution has several advantages as it supports both simple “AND” and “OR” chaining of conditions. AND conditions can be configured in a single rule. OR conditions can be configured in multiple rules with one rule per condition or the sub-set of AND conditions within the enclosing OR condition set. Additionally, it allows complex rule programming with an executable program, i.e. script, for conditions that cannot be met with simple AND/OR condition chaining.

### BRIEF DESCRIPTION OF THE DRAWINGS

FIG. 1 illustrates a block diagram depicting an example of the relationship between different entities used during the management of device data feeds.

FIG. 2 illustrates an example of a data model as defined by the system.

FIG. 3 illustrates an example of publishing device data to a receiver endpoint.

FIG. 4a is a flow diagram illustrating various steps involved in the process of data decoration.

FIG. 4b illustrates an example of data decoration mapping.

FIG. 5a is a flow diagram illustrating various steps involved in processing data using subscription rules.

FIG. 5b illustrates an example of a rule.

FIG. 6a is a flow diagram illustrating use of application programming interface (API) key for reading and/or posting data to containers.

FIG. 6b illustrates examples of reading and writing data and one “container” API for both data subscription and data query.

FIG. 7 illustrates an example of processing of raw device data as directed by subscription information, according to an embodiment of the present invention.

FIG. 8 illustrates a data processing system suitable for storing the computer program product and/or executing program code in accordance with an embodiment of the present invention.

### DETAILED DESCRIPTION

The present invention is directed to the management of data received from devices on a network.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention relates to any data received from a device operating on a network, whether the device is used by a human or is used in applications involving machine-to-machine communications. In any system involving devices on a network, data may be generated by devices for use by one or more end users. The data may be sent to some location for processing and, if applicable, storage and publishing to end users. Since different end users may only want to receive, or may only be authorized to receive, certain portions of the data feed from any given device, a method is required for processing the data and managing access by different end users.

FIG. 1 illustrates a block diagram of relationship between the resources associated with management of device data feeds and the publishing and consumption of the data. A device is associated with a data model 142, which is associated with a number of containers 144. A device posts data into the container 144 based on the data model 142 associated with that device and container 144. The container 144 is also associated with a subscription 146, meaning a set of rules and scripts associated with a particular end user or end user application. Each subscription 146 is associated with a rule 148, uniquely identified with the identifier of the subscription 146. The data posted in a container 144 is processed according to the subscription 146 associated with that container, according to the rules 148 associated with the subscription 146.

FIG. 2 illustrates an example of a data model as defined by the system, in accordance with one of the embodiments. As shown in the example, a data model comprises one or more data fields, for example, “name”, “type”. A container is associated with a specific data model depending on the data description for that data model. System uses data models to extract data fields from raw device data.

FIG. 3 sets forth a process for publishing device data to a receiver endpoint in accordance with one of the embodiments. A device posts data to a container via step 302 based on data description. The system looks up the data model associated with the container step 304 and stores the received data indexed by time step 306. The system then checks if the index is configured for any parameter on the data model via step 308. If it is, the system extracts the parameter from the device data and stores data by the value index of the parameter via step 310. If the index is not configured for any parameter, the system further checks if the data decoration for that data is configured via step 312. If the data decoration is configured, the system processes the data decoration via step 314. If the data decoration is not configured, the system looks up subscriptions associated with the container step 316. Alternatively, the system looks up subscriptions associated with the container step 316, after processing the data decoration. Thus, the system may or may not process data decoration depending on the configuration.

The system then checks if any subscription is configured, or associated, with the data via step 318. If it is, the system stores the device data in a queue for publishing via step 320, processes the subscription rules step 322 and publishes the processed data by forwarding it to a receiver endpoint as directed by the subscription rules step 324. However, if no subscription is configured, the data is stored away without further evaluation.

FIG. 4a is a flow diagram illustrating various steps involved in the process of augmenting or enriching received data with other external data to reduce the amount of data that a device needs to send and to improve usefulness to the end user through a process known as data decoration step 314 as shown in FIG. 3a. If data decoration is configured for any device data associated with a particular container, the system processes the data decoration step 314, by looking up decorator mappings from storage via step 402. The system then searches the device data for parameters that are also configured in data decorator mapping via step 404. If the data decorator parameters are found in the device data via step 406, the system adds the data decoration to the device data via step 408. The system then looks up subscriptions associated with the container via step 316 as shown in FIG. 3a.

FIG. 4b illustrates an example of data decoration mapping. For example, if the device data contains a parameter called “serial number” and the value of the parameter is “1234”, and that data is configured with data decoration mapping, then the gateway application or system, using decoration mapping, can add “taxi number” and “driver” to the data received from that device and store the data together with its data decorations and publish the processed data as described below. The end user may use this system as shown in the following example. A taxi company installs a tracking device having serial number 1234 in a taxi having vehicle number 22. The device is configured to send only location data associated with its device identification number, but the end user, the taxi company, also wants to know on which taxi this device is installed and which driver is currently driving the taxi. The end user taxi company configure an application enablement platform, also known as application middleware, to associate taxi number and driver name with a device serial number using a separate look up function by provisioning a “data decorator mapping on device serial number” in the application enablement platform. In the example, the application enablement platform will see the instruction for performing data decoration mapping on the data received from that device and then add taxi number and driver name in the device data before storing the augmented data feed in the container and the publishing queue. The application of the end user taxi company can now process the device data as if the device had sent the taxi number and driver name as well as the location data.

FIG. 5a is a flow diagram illustrating various steps involved in processing device feed data using subscription rules, step 322, as shown in FIG. 3a. The system checks if any subscription is configured with the data via step 318; if so, it stores the device data in a publishing queue based on the rule selected by the user (in this example, first in first out or FIFO) step 320, and processes subscription rules via step 322 as shown in FIG. 3a. To process the subscription rules, as shown in FIG. 5a, the system first retrieves the rule-set from the database via step 502. For each condition in the rule-set, it extracts a parameter value from the device data via step 504 and compares the parameter value from the device data to the value configured in the rule via step 506. If it finds that all conditions in a rule-set evaluated are true step 508, it further checks for a user script configured to process data via step 510. If a user script is so configured, it sends the data to the script engine for script execution step 512. If all conditions in a rule-set evaluated are not true or if no user script is configured to process data, the data is stored away without further processing via step 324 as shown in FIG. 3a.

FIG. 5b illustrates an example of a rule where device data is sent to a user script for processing if the value of the “light” parameter in the data equals to “20”. As shown in FIG. 5b, a subscription is associated with a rule. The rule comprises of one or more conditions resulting in actions, an action type based on an outcome of evaluation of the rules, and a set of instructions to be carried out by an executable program to carry out the action type based on the outcome of evaluation of the rules. A condition consists of 3 parts: parameter, operator and value. As illustrated in the rule example, “parameter” is defined as “light”, operator “op” is defined as “=” and “value” is defined as “20”. The rule example further illustrates “action type” defined as “EVAL”, and when all the conditions evaluated are true, the action specified in the subscription is performed as shown by “enabldSub”: “true.

FIG. 6a is a flow diagram illustrating use of an application programming interface (API) key to govern access to containers, either for devices to post data to the container or for end users or end user applications to retrieve data from a container. The application programming interface (API) key is created, in an embodiment, using an account key. The account key can also be an API key, however, an API key is not always an account key. An API key is assigned read/write privileges to individual resources whereas the account key is always assigned read/write privileges for all sources.

As the device data management system receives a request to write data to a container, for example from devices to post data, or to read data from a container, for example from end users with subscriptions to access data via step 602, it checks for the presence of an API key on the request via step 604. If no such key is found, the system rejects the request via step 606. If the API key is present on the request, the system then looks up the access rule assigned for this API key in the database via step 608. The request is rejected if the access rule is not found step 614. If the access rule is found it checks to see if the rule matches the requested action on the requested resource via step 612, for example read or write. If the rule matches the requested action, the request is allowed step 616, and if the rule does not match the requested action, the request is rejected step 614.

FIG. 6b illustrates examples of reading and writing data and one “container” API for both data subscription and data query. The device data management system may receive a request to write data to a container, such as when devices communicate with the system to post data, or to read data from a container, for example, from subscriber applications or from subscribers or other clients to access data. The access to data can be based on a subscription involving a push function, where the data is pushed to the end user or end user application after processing, or the subscription can allow the end user to send a query to retrieve data from the data management system, either as requested or according to a schedule. The system uses the URL path of the request to determine whether to retrieve data that has been placed in a queue for a push subscription or, to satisfy a one-time or scheduled polling query, to retrieve all data satisfying the query parameters.

FIG. 7 illustrates processing of raw device data as directed by subscription information, according to an embodiment of the present invention. System 700 comprises various containers and the performance of services associated with subscriptions on data in those containers. As shown, a device posts http messages with binary payload to raw data container 702 which contains a number of binary messages. The subscription configured to the raw data container 702 sends the data stream through a binary decoder service 704 and reposts the decoded and modified data to the decoded message container 706. The subscription configured to the decoded message container then posts the data through a message sent to the Json converter 708, which reposts the processed data to the Json message container 710. The subscription configured to the Json message container then posts the data through Augment Json Message 712 for processing using a data decoration mapping function or augmentation service and then posts augmented data to target message container 714 to which all the end users holding appropriate API keys 716 can subscribe to receive the augmented data.

FIG. 8 illustrates a data processing system 800 suitable for storing the computer program product and/or executing program code in accordance with an embodiment of the present invention. The data processing system 800 includes a processor 802 coupled to memory elements 804a-b through a system bus 806. In other embodiments, the data processing system 800 may include more than one processor and each processor may be coupled directly or indirectly to one or more memory elements through a system bus.

Memory elements 804a-b can include local memory employed during actual execution of the program code, bulk storage, and cache memories that provide temporary storage of at least some program code in order to reduce the number of times the code must be retrieved from bulk storage during execution. As shown, input/output or I/O devices 808a-b (including, but not limited to, keyboards, displays, pointing devices, etc.) are coupled to the data processing system 800. I/O devices 808a-b may be coupled to the data processing system 800 directly or indirectly through intervening I/O controllers (not shown).

In FIG. 8, a network adapter 810 is coupled to the data processing system 802 to enable data processing system 802 to become coupled to other data processing systems or remote printers or storage devices through communication link 812. Communication link 812 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-RAN). To describe the features of the present disclosure in more detail refer now to the following description in conjunction with the accompanying Figures.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

Similarly, it is envisioned by the present invention that the term communications network includes communications across a network (such as that of a network for machine-to-machine or M2M communications but not limited thereto) using one or more communication architectures, methods, and networks, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, wireless local area network (WIFI), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. Many other embodiments of the present invention are also envisioned.

What is claimed is:

1. A computer-implemented method for managing device data feeds comprising:
using a data description to describe type of data received from plurality of devices,
grouping the received type of data into a plurality of containers based on a data model, and
configuring at least one subscription identifier to at least one of the plurality of containers, wherein the at least one subscription identifier is associated with a receiver endpoint and at least one rule identified by the subscription identifier.

2. The computer-implemented method of claim 1 for managing device data feeds wherein the at least one rule is applied to any of one or more conditions, with a type of action, resulting based on an outcome of application of the rules, to be performed on the device data through and use of an executable program and using application programming interface key to manage access to the device data following performance of the action.

3. A computer-implemented system for managing device data feeds comprising:
a gateway between a device and a receiver endpoint;
wherein the gateway is configured with
a data model of a device data feed to allow the gateway to interpret data received from the device, and
subscription information associated with the device data feed wherein the subscription information comprises a receiver endpoint, and at least one rule uniquely identified by the subscription's identifier.

4. The computer-implemented method of claim 1 for managing device data feeds comprising:
using at least one rule to determine if an action involving augmentation of data is to be performed,
if the condition of the rule is satisfied, using an executable program to associate external data located in a data store associated with the device data feed, and
processing the augmented data in accordance with the associated subscription information.

5. The computer-implemented system of claim 3 for managing device data feeds wherein the at least one rule comprises any of
one or more conditions resulting in actions,
an action type based on an outcome of evaluation of the rules, and
a source code of an executable program to carry out the action type based on the outcome of evaluation of the rules.

6. The computer-implemented system of claim 4 for managing device data feeds further comprising:
configuring the at least one rule with a programming source code, wherein the action type is to send the device data to an internal system process to execute the source code.

7. A computer program product stored on a computer readable medium for managing device data feeds, comprising computer readable programming for causing a computer to control an execution of an application for managing device data feeds comprising:
using a data model to describe type of data received from plurality of devices,
grouping the received type of data into a plurality of containers based on a data description, and
configuring at least one subscription identifier to at least one of the plurality of containers, wherein the at least one subscription identifier is associated with a receiver endpoint and at least one rule identified by the subscription identifier,

8. The computer program product of claim 7, wherein the at least one rule comprises of any of one or more conditions resulting in actions, an action type based on an outcome of evaluation of the rules, and a source code of an executable program to carry out the action type based on the outcome of evaluation of the rules using application programming interface key to manage access to the device data.

9. The computer program product of claim 7, further comprising instructions for:
configuring the at least one rule with a programming source code, wherein the action type is to send the device data to an internal system process to execute the source code.
